(19) United States
(12) Patent Application Publication
(10) Pub. No.: US 2005/0278311 A1
(43) Pub. Date: Dec. 15, 2005

(54) System and method for generating advertisements utilizing a database of stock imagery

(76) Inventors: Trent Moore, Riverview, FL (US); Karl Cartwright, Dacula, GA (US)

Correspondence Address: Michael J. Colitz, III;Holland & Knight LLP, Suite 4100, 100 N. Tampa Street, Tampa, FL, 33602-3644, US

(21) Appl. No.: 10/862,832

(22) Filed: Jun. 7, 2004

(51) Int. Cl. G06F 7/00

(52) U.S. Cl. 707/3

(57) ABSTRACT

A fully automated, computerized advertisement design system and method for creating and retrieving completed advertising pieces is provided. The system and method uses a database of images or stored art pieces and provides users with the ability to edit size, text, fonts, layout and color. The final art piece is created by selecting an image indexed by category, selecting layout, typing appropriate text, reviewing, editing, sizing and finally storing and/or printing of the advertisement.

### BACKGROUND OF THE INVENTION

1. Field of the Invention

This invention relates to a system and method for the computerized generation of advertisements. More particularly, the present invention relates to using a database of stock images to electronically generate print or electronic advertisements of various sizes.

2. Description of the Background Art

Presently, computerized advertisement pagination is known in the art. For example, U.S. Pat. No. 5,911,146 to Johari et al. discloses an apparatus and method for automatic yellow pages pagination and layout. The system of Johari determines possible candidate layouts by randomly setting parameters defining the pagination and layout. Candidate solutions are optimized through an iterative process of perturbations, scoring and comparing. Thereafter, a best solution is selected from all optimized candidate solutions. However, the system of Johari is for pagination and printing of coupled art work, and it makes no provision for the creation of artwork.

The general state of the art is also described in U.S. Pat. No. 5,390,354 to de Heus et al. De Heus discloses a computerized directory pagination system and method. The system accepts galley entries as an input and then works out an optimal page layout according to a set of pagination parameters, including size, shape, type and page format directory rules. Sorting operations are performed on the input data automatically and in sequential phases of a programmed sequence, so that when the operations are finished an entire paginated directory is produced. Again, de Heus does not contemplate the creation of advertising art or content.

Still yet another method is disclosed in U.S. Pat. No. 5,553,217 to Hart et al. The method of Hart calculates multiple document layouts while maintaining the correct reading order of the picture and text objects at all times. The method positions each picture and text object at multiple anchor points to create multiple document layouts and then selects a best document layout, which is the layout using the least number of pages to display an entire list of objects.

Although each of the above referenced inventions achieves its individual objective, they all suffer from common problems. Namely, none of the prior methods utilizes an indexed database of stock images to allow users to easily generate customized advertising layouts. Thus, there exists a need in the art for a computerized system for efficiently creating advertisement text and for combining that text with suitable images.

### SUMMARY OF THE INVENTION

It is therefore one of the objectives of this invention to provide a computerized system for efficiently creating advertisements.

It is also an object of this invention to provide a system wherein text and artwork can be easily combined to form an advertisement.

Still another object of this invention is to allow users to electronically create advertisements via an intuitive and graphically driven interface.

Another object of the invention is to provide an automated program that uses an index of images to create advertising materials without the need for an artist.

Yet another object of the invention is to allow for the storage, indexing and retrieval of completed advertisements, as well as to allow for subsequent viewing and editing of advertisements.

Still yet another object of the invention is to allow a user to manipulate created advertisement into various sizes.

These and other objectives are accomplished through a method for the computerized generation of advertisements. The method involves inputting data relevant to the advertisement into predefined text fields, with the fields being represented at specified areas within the advertisement. A database of stock photography is maintained for use within the advertisement, with the database being indexed according to various categories of advertisements. An individual photograph from the database can then be selected for insertion into the advertisement.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart of the method of the present invention.

FIG. 2 is a flow chart of a specific application of the method of the present invention.

FIG. 3 is a screen shot of system of the present invention.

Similar reference characters refer to similar parts throughout the several views of the drawings.

### DETAILED DESCRIPTION OF THE PREFERRED EMBODIMENT

The present invention relates to a system and method for the computerized generation of advertisements. The system includes a computer running document presentation/editing software and a database of stock images. The system allows a user, by way of the software, to create advertising text, and thereafter combine the text with images from the database. The software also allows users to easily resize created advertisements to a form suitable for use within the intended advertising space. The various features of the present invention, and the manner in which they interrelate, will be described in greater detail hereinafter.

The components that make up the system of the present invention are first described. The system utilizes a computer, which can be a personal computer (such as a laptop or desktop) running a number of different programs or a workstation dedicated to carrying out the method of the present invention. The system further includes software running on the computer that generates advertisements in accordance with the method of the present invention. The software may be resident on the computer or it may be accessed remotely via the Internet or other suitable computer network, such as a Local Area Network (LAN). The system further includes a database for storing images, such as photographs or artwork.

The software used by the system is preferably a version of Adobe Acrobat® that has additional and enhanced functionality via the use of a JavaScript. An Acrobat JavaScript Object ADBC (Adobe Data Base Connectivity) application can also be used. Other software can also be employed in carrying out the present invention, including either especially written software or commercially available software that has been modified to achieve the objectives stated herein.

The system's database can take the form of a conventional computer hard drive that is accessed by the computer. As noted above, the database is employed in storing a variety of different stock photographs and/or artwork. These images can be stored in any number of different formats, such as Joint Photographic Experts Group format (jpeg), Portable Document Format (PDF), Tagged Image File Format (tiff) or Graphic Interchange Format (gif). The preferred bitmap standard will largely depend upon the type of software being employed by the system. As will be described below, the system is advantageously designed to allow users to conveniently create advertising text and thereafter combine it with images from the database. The created advertisements can then be stored in the database for later use.

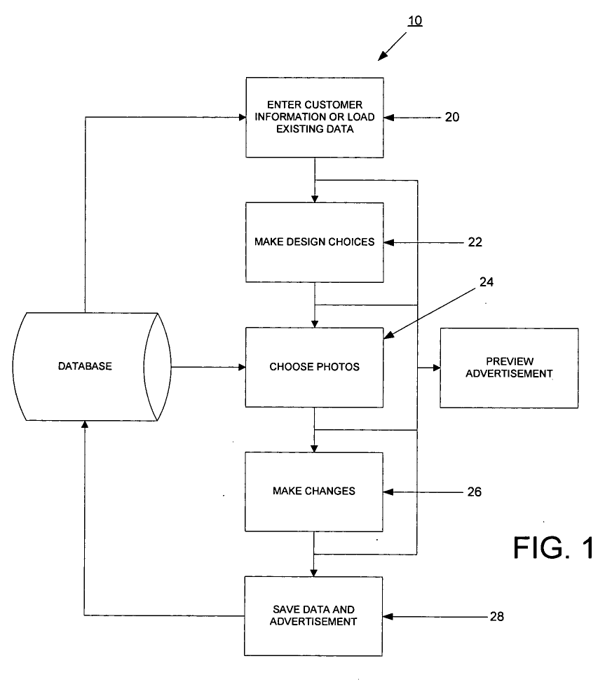

With reference now to FIG. 1, the method of the present invention 10 is broadly depicted. As noted at step 20 of the block diagram, the software program will first invite a user to enter information about a customer. The “customer” in this context is the individual contemplating the purchase of advertising space in a publication. The “user” will generally be a representative of the publication who is seeking to sell advertising space to the customer. The information entered during this initial step is the contact information of the customer. This contact information is stored in the database to be recalled by the user at a later time, such as a future sales call.

As further noted in the block diagram of FIG. 1, the software can then be used to create an advertisement via a series of design choices, as noted at step 22. This is done by drafting text that describes the customer's business. Thereafter, at step 24, the customer can review various stock photography and/or artwork in the database and select imagery to be included in the advertisement. At step 26, the text can then be modified and the image changed as desired. The completed advertisement is then stored, as indicated at step 28, in the database along with the associated customer contact information.

Thus, the system of the present invention is ideally suited to sales people who may be selling advertising space in a publication, such as the yellow pages, a newspaper and/or a magazine. The present invention may also be used in the sale of electronic advertising space, such as Websites or E-mail. The system can be conveniently employed by the user on a laptop computer. In this way the user can travel to a customer's location and quickly generate a sample advertisement for consideration by the customer. If the customer is not interested, the sample advertisement can later be easily recalled along with the potential customer's contact information.

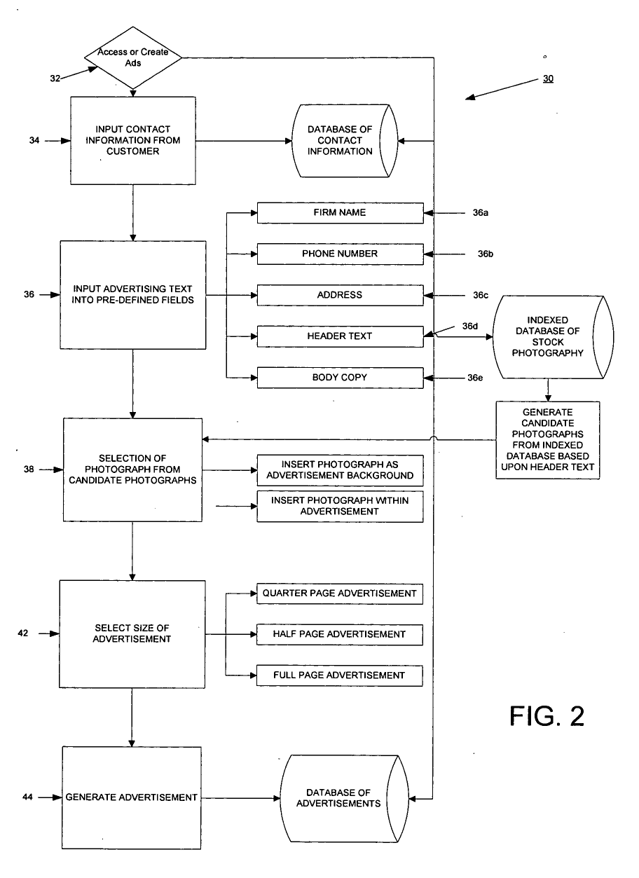

FIG. 2 is a depiction of a more detailed embodiment of the present invention 30. In the first step 32, the user decides to either pull-up an existing advertisement from a database or generate a new advertisement. Assuming the user chooses to generate a new advertisement, they are first prompted to input the customer's contact information at step 34. The database of contact information can be separate from the database of stock photography and the database of advertisements. Alternatively, all three sets of data can be stored within one database.

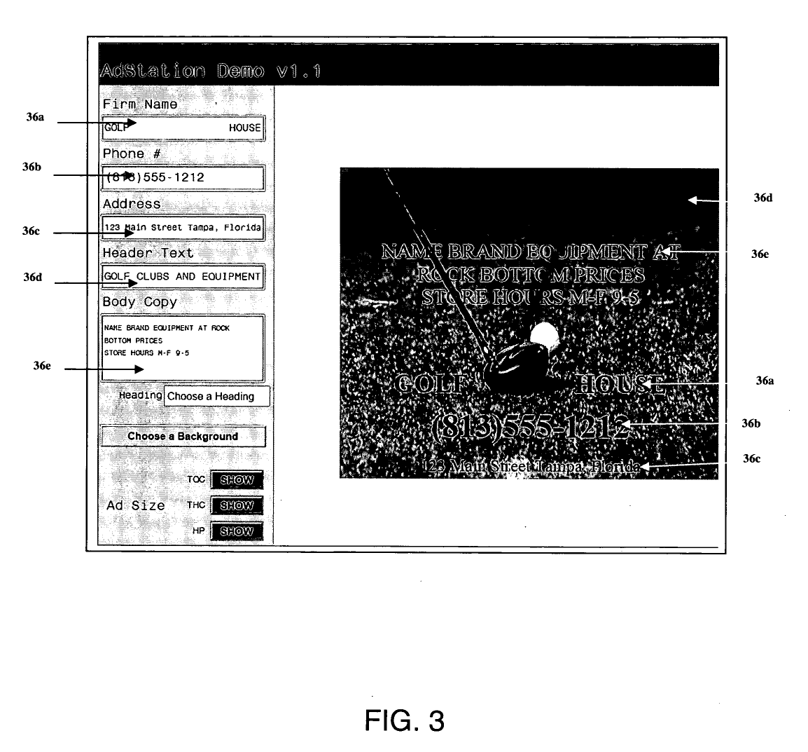

Next, at step 36 text is generated for inclusion in the advertisement. In the preferred embodiment, the software has an intuitive graphical interface of the type depicted in FIG. 3. This graphical interface includes a number of fields for inserting the text of the advertisement. The user can easily type the relevant information into each of these fields. For example, as noted in FIGS. 2 and 3, the text fields include “firm name,” “phone number,” “address,” “header text,” “body copy.” These fields are indicated at 36a, 36b, 36c, 36d and 36e, respectively. This, however, is just a representative example of the types of text fields that can be used. The particular text fields that are included will be established by the software and depend upon the nature of the advertisement being generated. In this regard, a series of advertising “templates” are stored in the database to be called up depending on the type of advertisement being generated. Each template has its own unique text fields (with pre-set font and point size formatting) for insertion into particular locations within the advertisement. These templates can be altered by the user as needed.

Upon entering the text into the text fields, the text is stored in the database for subsequent use. Once the text is entered and saved, the software places the text into predefined areas in the advertisement, as noted by FIG. 3. Thus, there is no need to re-enter data if the user subsequently wishes to change or re-design the advertisement. The software may also enlarge selected portions of the text depending upon its placement within the advertisement. For example, FIG. 3 illustrates the creation of a yellow pages advertisement. The “firm name” 36a is first typed into the text field on the left. The text is thereafter placed into a pre-designated area within the advertisement; in this example, in the lower one-third of the advertisement, designated by 36a, adjacent the telephone number of the business. However, insomuch as this is a yellow pages advertisement, the phone number has been slightly enlarged relative to the other text fields, such as address field 36c.

In the next step, indicated in FIG. 2 as 38, photographs or images are selected from the database of stock photography. In the preferred embodiment, the database of stock images are indexed in accordance with the type of advertisement that is being generated. For example, all images of automobiles may be placed in an index for car dealerships, and images of flowers may be placed in a florist index. Some images may be included in two or more indexes as necessary. An image of a golfer, for instance, may be indexed under sporting goods as well as country clubs. In one embodiment of the present invention, the software automatically selects the appropriate index (or indexes) based upon the information entered into the text fields. For instance, in the yellow pages advertisement of FIG. 3, the information entered into the “header text” field 36d is used to automatically select a relevant index. If the user enters “golf clubs and equipment” into this field, an appropriate search of the indexes will be performed and an appropriate index selected.

Once an index is selected, a list of candidate photographs from photographs in the index is generated. These candidate photographs are presented to the user by way of the graphical interface. The user next selects the desired image and decides whether to include it within just a portion of the advertisement or whether it will be used as the background for the advertisement. For instance, the candidate photographs can be presented in a thumbnail format and thereafter selected by double -clicking on the individual thumbnail.

Next, at step 42, the size of the advertisement is selected. Preferably, as noted by the graphical interface in FIG. 3, one of several advertisement sizes will be presented to the user. The advertisement sizes presented will again depend upon the type of advertisement that is being generated. In the yellow pages advertisement of FIG. 3, the sizes are: quarter page ad, half page ad or full-page ad. Once the size is selected the software will automatically re-size the advertisement to the selected dimensions. The text and image portions will be proportionately sized in accordance with the selected advertisement size. Once the advertisement size is selected, the finished advertisement will be generated at step 44 with the text displayed in the appropriate text fields and the image displayed in the appropriate location. The image can then be printed out or stored, in any of the above mentioned bit map formats, in the database for retrieval at a subsequent time.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

1. A method for the computerized generation of yellow pages advertisements for particular yellow pages customers, the method comprising in combination:
inputting contact information regarding the yellow pages customer who is seeking a yellow pages advertisement, the contact information including an individual's name, address and phone number;
storing the contact information of the yellow pages customer into a database for future reference;
inputting data relevant to the yellow pages advertisement into predefined text fields, the text fields including firm name, phone number, address, header text and body copy, the text fields appearing at pre-designated areas in the yellow pages advertisement;
maintaining a database of stock photography for use within the yellow pages advertisement;
indexing the database of stock photography according to various categories of yellow pages advertisements;
selecting a particular category from the database of stock photography on the basis of the inputted data;
selecting an individual photograph from the selected category for insertion into the yellow pages advertisement;
selecting the size of the yellow pages advertisement and dimensioning the text fields and selected photograph accordingly;
generating an electronic image of the yellow pages advertisement and storing it in a database.

2. A method for the computerized generation of print or electronic advertisements comprising:
inputting data relevant predefined text fields, the text fields appear in the advertisement;
maintaining a database of stock photography for use within the advertisement;
indexing the database of stock photography according to various categories of advertisements;
selecting an individual photograph from the database for insertion into the advertisement.

3. The method as described in claim 2 wherein a user can select the size of the advertisement and wherein the pre-defined text fields are dimensioning accordingly.

4. The method as described in claim 2 further comprising the step of generating a print copy of the generated advertisement.

5. The method as described in claim 2 wherein the advertisement is a yellow pages advertisement.

6. The method as described in claim 2 wherein the text fields appear in pre-designated areas within the advertisement.

7. The method as described in claim 2 wherein the text fields include fields for firm name, phone number, address, header text and body copy.

8. The method as described in claim 2 wherein a category of photograph is automatically selected on the basis of inputted data.

9. The method as described in claim 2 wherein once an advertisement is generated it is stored within a database for future reference.

10. A system for automatically generating an advertisement comprising:
a computer and an associated database, the database being used to store a variety of stock photography for use within the advertisement, the database being indexed into various photograph categories of advertisements;
a software program for allowing a user to enter information concerning the advertisement into certain pre-defined text fields, the software program further selecting a photograph category on the basis of the entered information.
